(19) United States
(12) Patent Application Publication
(10) Pub. No.: US 2008/0095162 A1
(43) Pub. Date: Apr. 24, 2008

(54) Communications system

(76) Inventors: Heru Khoe, Baldwin Park, CA (US); Steve Ganiputra Hidajat, Baldwin Park, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/584,054

(22) Filed: Oct. 20, 2006

(51) Int. Cl. H04L 12/56

(52) U.S. Cl. 370/392

(57) ABSTRACT

A communications addressing system includes first and second communication devices. The first device is capable of at least sending a message using a system specific transmission protocol. The message has a content portion and an addressing portion. The addressing portion includes a unique identifier of an identified receiving entity. An entity identification system provides a least one communication link for a system specific transmission protocol which is derived from the unique identifier of the receiving entity. A security filter screens messages sent to the identified receiving entity. The second communication device is capable of at least receiving a message using at least one system specific transmission protocol. When a sending entity transmits a message using the unique identifier to the entity identification system, it will determine a communication link for at least one system specific transmission protocol for the identified receiving entity and transmit the message through the security filter.

### FIELD OF INVENTION

The invention pertains to communications systems and means for identifying recipients of communications. More particularly, the invention relates to systems that uniquely identify communicating entities and provide filtering and screening mechanisms to protect the privacy and security of the recipients.

### BACKGROUND OF THE INVENTION

Communications systems have traditionally required a unique identifier for each entity involved in a communications interchange. Typical examples include telephone numbers, street addresses, radio call signs and more recently, Internet addresses. As long as the entity desiring to initiate a communication had the unique identifier of the entity that it wished to contact, the communication was easily initiated. Circumstances exist, however, where the entity desiring to initiate a communication does not have the identifying information of the party to be contacted. Or conversely, an entity may wish to make itself available for communication to a wide group of entities but wish to return some control over which other entities may contact it. Various inventions have been developed to address these concerns for modern communication systems.

U.S. Pat. No. 5,016,270, issued to Katz discloses a database that stores data on individual automobiles, addressed by alphanumeric-code license designations. Access to the memory also is provided from individual telephone terminals through an interface structure with digital and audio capability in association with a code translation unit which enables use of telephone keypad compatible codes to address the memory. The translation involves the addition of a check digit. A caller accessing data on a specific automobile may renew the license and in that regard infractions are policed. Also, billing is performed through a credit system with verification.

U.S. Pat. No. 5,668,880, issued to Alajajian is directed to a device for wireless, secure transmission of digital information signals utilizing carrier sense multiple access packet communications, or spread spectrum code division multiple access circuits, between a plurality of stations. The device is intended for use within motor vehicles. The digital information signals may be data or compressed voice signals. Each device operates using a visual network access schema under which the operator of each station manually enters, into the device keyboard, the license plate number of the Target vehicle to be contacted. The license plate number of the Target motor vehicle is used by the Sender device to identify the transmission parameters to the Target device. These parameters are the network address, data link address, frequency channel, code division multiple access (CDMA) code, and encryption key. A Target device uses its own license plate number and that of the Sender vehicle to identify the transmission parameters for delivering a response. Each device contains two receive channels; one for reception of broadcast packet messages or CDMA circuits, and the other for directed packet messages, including signaling messages for the CDMA circuits. To support broadcast messages, the use of a pseudo license plate number, or common address, is entered by the operator of the Sender device. A preferred set of broadcast addresses supports specific types of broadcasts, such as, emergency distress messages (“EBROAD”), traffic reports (“TBROAD”), or general broadcast messages (“GBROAD”). The device consists of ten major components. The reference also discloses that if a certain type of message is selected, the user will be prompted to enter certain additional data.

U.S. Pat. No. 5,847,661, issued to Ricci illustrates an intervehicular communication system for communicating between a first vehicle and a second vehicle having a first and second registration numbers. The invention includes a transmission means disposed in the first vehicle for transmitting a message to the second vehicle by addressing the message with the second registration number where the message has the first registration number disposed therein; and reception means disposed in the second vehicle for receiving the message and projecting the message to an operator of the second vehicle, the reception means further being adapted to store the first registration number upon receipt of the message to enable to return response to the message to the first vehicle without additional addressing by a user.

U.S. Pat. No. 6,571,279, issued to Herz, et al. discloses a Location Enhanced Information Deliver System Architecture (LEIA) that customizes the information that is displayed to an information recipient based on optimizing a match between information purveyors, such as advertisers, and the information recipients who are local to an information delivery system. The present location enhanced information delivery system presents the information most suited to the real current audience, as measured by location information systems, rather than to a static predicted audience. While the preferred embodiment discloses a beaconing-style wireless technology, the system concept is easily extensible both to other location-information systems, such as license-plate scanning with cameras, and to utilizing the location-information for private displays of information in addition to public displays of information.

U.S. Pat. No. 6,366,913, issued to Fitler, Jr., et al. is directed to a method whereby application and network services (such as access control and electronic mailing list servers) can use a directory service to define groups of directory members using a directory search specification evaluated at service delivery time (dynamic group membership.) Traditionally, network services have been delivered to groups of users defined in relatively narrow manners: either by keeping a list of all users who are members of the group, or by attaching specific group membership attribute information to the information maintained about each specific user. Dynamic group membership allows these services to be delivered to groups of users who can be defined by a completely arbitrary specification of user attribute information. For example, electronic mail can be sent to a group of users whose office was located in a certain building (specifically, whose office location attribute matched a specific value.) Another example is that users may be permitted to access a network service, such as a printer, based on whether the printer is in the same building as the user (specifically, whether the printer's location attribute matches the user's office location attribute).

U.S. Pat. No. 6,641,038, issued to Gehlot, et al. discloses a smart vehicle registration plate for a vehicle have a computing unit configured to process vehicle related information, and a display, the display having one or more information display regions, for displaying the vehicle related information. The information display regions may be updateable by the computing unit as a function of changes to the vehicle related information. Additionally, the Smart Vehicle Registration Plate may also communicate and exchange data with other Smart Vehicle Registration Plates or outside entities such as the Department of Motor Vehicles, police, or emergency workers, and the like. Some non-limiting examples of displayed vehicle related information may be a vehicle registration number; an expiration date; a state identifier; an emergency message; a personal message region; a country identifier; a county identifier; last accident/violation region; and the driver's experience driving in a particular geographic area.

U.S. Pat. No. 6,748,682, issued to Sims describes a system and method of incorporating a vehicle license plate into a larger, final message by attaching one or more message panels to all exterior of a motor vehicle, such as the bumper, in combination with a license plate of the motor vehicle. At least one message panel is attached to the exterior of the motor vehicle adjacent to a license plate. File message panels may be in sign, sticker, or magnet form and may be place before, alter above, and/or below the license plate. The message panels may have message panel background designs or additional text that continues the license plate background design and/or message. For example, a first message panel stating a global computer network address prefix, e.g., “www.”, may be placed before a license plate while a second message panel stating a global computer network address suffix, e.g., “.com”, may be placed after the license plate to convey a global computer network address to a viewer.

U.S. Pat. No. 6,816,085, issued to Haynes, et al. discloses a method for managing a parking lot. In one disclosed embodiment, the method includes receiving parking lot data. The embodiment of the disclosed method also includes transforming the parking lot data into parking lot information, the parking lot information including information about a moving parking lot object. Further, the embodiment of the disclosed method includes transmitting a map of the parking lot to a mobile interaction device, and transmitting the parking lot information to the mobile interaction device. Advertising may also be transmitted, the advertising can be general, targeted to shoppers or users of the premises associated with the parking lot, and/or targeted specifically to a particular vehicle, person, or group of persons. By way of example, a general advertisement could be directed to a cold remedy. A premises-directed advertisement could advertise a special entree associated with a restaurant on or near the premises. A more targeted advertisement could be sent to an aging minivan, advertising the benefits of a new minivan model. An even more targeted advertisement could be selected based on a database lookup using the minivan's license plate, the database containing demographic, income, spending, and/or lifestyle information about the owner and/or likely occupants of the minivan.

It is an objective of the present invention to provide a method for addressing an entity with which one wishes to communicate. It is a further objective to provide a method for making an entity available for communication to a large group of other entities. It is a still further objective of the invention to provide means for screening potential communicators before an entity will accept communication. It is yet a further objective to provide multiple methods for addressing the same entity. Finally, it is an objective of the present invention to provide communications addressing methods that are compatible with existing systems.

While some of the objectives of the present invention are disclosed in the prior art, none of the inventions found include all of the requirements identified.

### SUMMARY OF THE INVENTION

The present invention addresses all of the deficiencies of prior art communication systems inventions and satisfies all of the objectives described above.

(1) A communications addressing system providing the desired features may be constructed from the following components. A first communication device is provided. The first device is capable of at least sending a message using a system specific transmission protocol. A message is provided. The message has a content portion and an addressing portion. The addressing portion includes a unique identifier of an identified receiving entity. An entity identification system is provided. The identification system provides a least one communication link for a system specific transmission protocol. The at least one link is derived from the unique identifier of the receiving entity. A security filter is provided. The filter screens messages sent to the identified receiving entity. A second communication device is provided. The second device is capable of at least receiving a message using at least one system specific transmission protocol. When a sending entity transmits a message that includes the unique identifier to the entity identification system, the system will determine a communication link for at least one system specific transmission protocol for the identified receiving entity and transmit the message to the receiving entity through the security filter.

(2) In a variant of the invention, the communication devices are selected from the group consisting of cellular telephones, personal digital assistants, computers, portable music storage systems, global positioning systems and pagers.

(3) In a further variant, the message is in a format selected from the group consisting of text messages, image files, video files, audio files and streaming video files, e-mail messages, and combinations of text messages, image files, video files, audio files, streaming video files and e-mail messages.

(4) In still a further variant, the unique identifiers are selected from the group consisting of license plate numbers, addresses, Social Security numbers, drivers' license numbers and selected number, letter and symbol combinations.

(5) In yet a further variant, the security filter sorts incoming messages into open, selected and closed categories.

(6) In still a further variant, the open category includes all incoming messages.

(7) In another variant of the invention, the selected category includes messages from all entities selected by the receiving entity.

(8) In still another variant, the closed category includes no incoming messages.

(9) In yet another variant, the entity identification system provides use of a communication link to a system specific transmission protocol without disclosing the link to the sending entity.

(10) In a further variant, the entity identification system provides use of a communication link to a system specific transmission protocol to a plurality of unknown sending entities without disclosing the link to the sending entities.

(11) In still a further variant, displayable identification is provided to potential receiving entities to inform the public that the receiving entities can be contacted through use of their unique identifier.

(12) In yet a further variant, the receiving entity enters or removes acceptable unique identifiers into the entity identification system.

(13) In another variant of the invention, the receiving entity enters a least one communication link for a system specific transmission protocol for each acceptable unique identifier entered.

(14) In still another variant, the sending entity selects the system specific transmission protocol to be used to communicate with the receiving entity.

(15) In yet another variant, the receiving entity selectively specifies activation of an automated return message for at least one unique identifier through which messages are received.

(16) In a final variant of the invention, the receiving entity arranges automated billing to the sending entity through the entity identification system for products or services requested by and delivered to the sending entity.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic illustration of a first embodiment of the communications system;

FIG. 2 is a schematic illustration of displayable identification for users of the FIG. 1 system;

FIG. 3 is a schematic illustration of the FIG. 1 embodiment providing automated billing of a sending entity for products or services ordered through the FIG. 1; and

FIG. 4 is a schematic illustration of message types typically used by the FIG. 1 embodiment.

### DETAILED DESCRIPTION OF THE PREFERRED EMBODIMENT

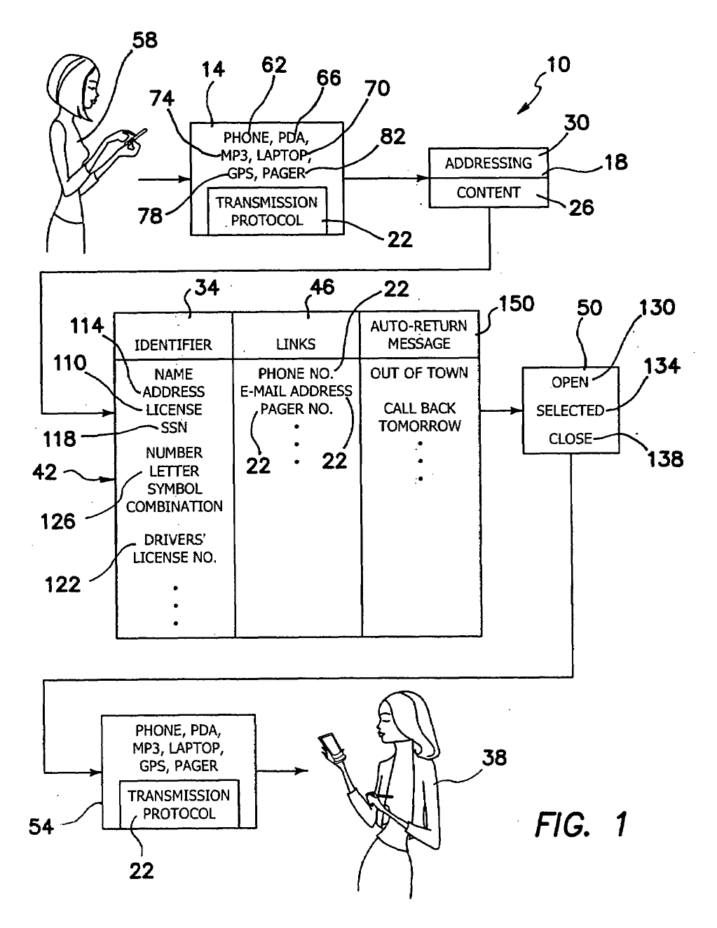

(1) FIGS. 1-4 illustrate a communications system 10 providing the desired features that may be constructed from the following components. A first communication device 14 is provided. The first device 14 is capable of at least sending a message 18 using a system specific transmission protocol 22. A message 18 is provided. The message 18 has a content portion 26 and an addressing portion 30. The addressing portion 30 includes a unique identifier 34 of an identified receiving entity 38. An entity identification system 42 is provided. The identification system 42 provides a least one communication link 46 for a system specific transmission protocol 22. The at least one link 46 is derived from the unique identifier 34 of the receiving entity 38. A security filter 50 is provided. The filter 50 screens messages 18 sent to the identified receiving entity 38. A second communication device 54 is provided. The second device 54 is capable of at least receiving a message 18 using at least 10 one system specific transmission protocol 22. When a sending entity 58 transmits a message 18 that includes the unique identifier 34 to the entity identification system 42, the system 42 will determine a communication link 46 for at least one system specific transmission protocol 22 for the identified receiving entity 38 and transmit the message 18 to the receiving entity 38 through the security filter 50.

(2) In a variant of the invention, the communication devices 14, 54 are selected from the group consisting of cellular telephones 62, personal digital assistants 66, computers 70, portable music storage systems 74, global positioning systems 78 and pagers 82.

(3) In a further variant, as illustrated in FIG. 4, the message is in a format selected from the group consisting of text messages 86, image files 90, video files 94, audio files 98 and streaming video files 102, e-mail messages 106, and combinations of text messages 86, image files 90, video files 94, audio files 98, streaming video files 102 and e-mail messages 106.

(4) In still a further variant, as illustrated in FIG. 1, the unique identifiers are selected from the group consisting of license plate numbers 110, addresses 114, Social Security numbers 118, drivers' license numbers 122 and selected number, letter and symbol combinations 126.

(5) In yet a further variant, the security filter 50 sorts incoming messages 18 into open 130, selected 134 and closed 138 categories.

(6) In still a further variant, the open category 130 includes all incoming messages 18.

(7) In another variant of the invention, the selected category 134 includes messages 18 from all entities selected by the receiving entity 38.

(8) In still another variant, the closed category 138 includes no incoming messages 18.

(9) In yet another variant, the entity identification system 42 provides use of a communication link 46 to a system specific transmission protocol 22 without disclosing the link 46 to the sending entity 58.

(10) In a further variant, the entity identification system 42 provides use of a communication link 46 to a system specific transmission protocol 22 to a plurality of unknown sending entities 58 without disclosing the link 46 to the sending entities 58.

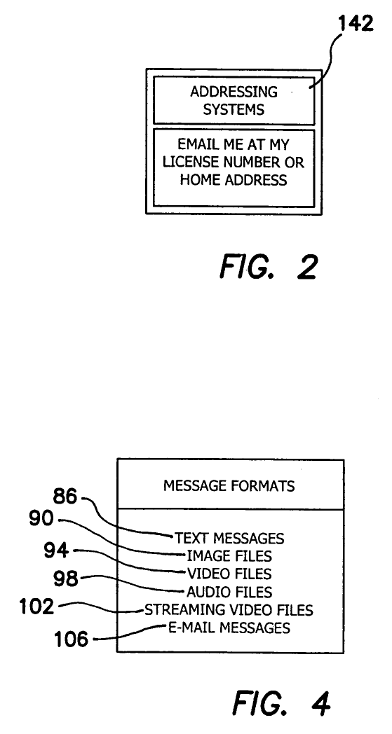

(11) In still a further variant, as illustrated in FIG. 2, displayable identification 142 is provided to potential receiving entities 38 to inform the public 146 that the receiving entities 38 can be contacted through use of their unique identifier 34.

(12) In yet a further variant, the receiving entity 38 enters or removes acceptable unique identifiers 34 into the entity identification system 42.

(13) In another variant of the invention, the receiving entity 38 enters a least one communication link 46 for a system specific transmission protocol 22 for each acceptable unique identifier 34 entered.

(14) In still another variant, the sending entity 58 selects the system specific transmission protocol 22 to be used to communicate with the receiving entity 38.

(15) In yet another variant, the receiving entity 38 selectively specifies activation of an automated return message 150 for at least one unique identifier 34 through which messages 18 are received.

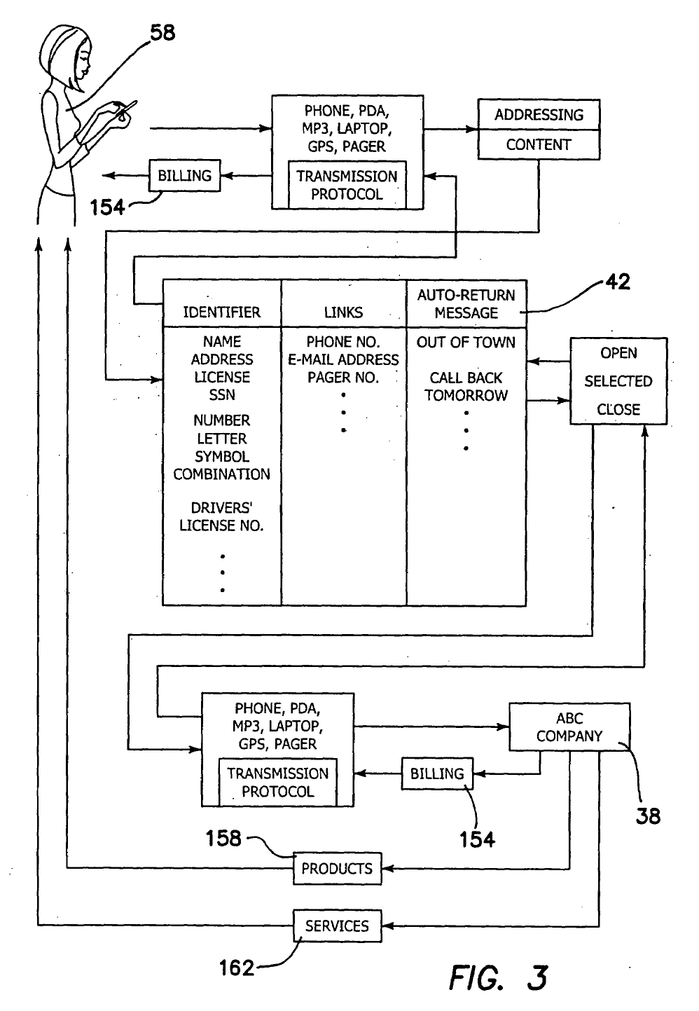

(16) In a final variant of the invention, as illustrated in FIG. 3, the receiving entity 38 arranges automated billing 154 to the sending entity 58 through the entity identification system 42 for products 158 or services 162 requested by and delivered to the sending entity 58.

The communications system 10 has been described with reference to particular embodiments. Other modifications and enhancements can be made without departing from the spirit and scope of the claims that follow.

1. A communications addressing system, comprising:
a first communication device, said first device capable of at least sending a message using a system specific transmission protocol;
a message, said message having a content portion and an addressing portion, said addressing portion comprising a unique identifier of an identified receiving entity;
an entity identification system, said identification system providing a least one communication link for a system specific transmission protocol, said at least one link derived from said unique identifier of said receiving entity;
a security filter, said filter screening messages sent to said identified receiving entity;
a second communication device, said second device capable of at least receiving a message using at least one system specific transmission protocol; and
whereby, when a sending entity transmits a message comprising said unique identifier to said entity identification system, said system will determine a communication link for at least one system specific transmission protocol for said identified receiving entity and transmit said message to said receiving entity through said security filter.

2. The communications system, as described in claim 1, wherein said communication devices are selected from the group consisting of:
cellular telephones, personal digital assistants, computers, portable music storage systems, global positioning systems and pagers.

3. The communications system, as described in claim 1, wherein said message is in a format selected from the group consisting of:
text messages, image files, video files, audio files and streaming video files, e-mail messages, and combinations of text messages, image files, video files, audio files, streaming video-files and e-mail messages.

4. The communications system, as described in claim 1, wherein said unique identifiers is selected from the group consisting of:
license plate numbers, addresses, Social Security numbers, drivers' license numbers and selected number, letter and symbol combinations.

5. The communications system, as described in claim 1, wherein said security filter sorts incoming messages into open, selected and closed categories.

6. The communications system, as described in claim 5, wherein said open category includes all incoming messages.

7. The communications system, as described in claim 5, wherein said selected category includes messages from all entities selected by said receiving entity.

8. The communications system, as described in claim 5, wherein said closed category includes no incoming messages.

9. The communications system, as described in claim 1, wherein said entity identification system provides use of a communication link to a system specific transmission protocol without disclosing said link to said sending entity.

10. The communications system, as described in claim 1, wherein said entity identification system provides use of a communication link to a system specific transmission protocol to a plurality of unknown sending entities without disclosing said link to said sending entities.

11. The communications system, as described in claim 1, wherein displayable identification is provided to potential receiving entities to inform the public that the receiving entities can be contacted through use of their unique identifier.

12. The communications system, as described in claim 1, wherein said receiving entity either of enters and removes acceptable unique identifiers into said entity identification system.

13. The communications system, as described in claim 12, wherein said receiving entity enters a least one communication link for a system specific transmission protocol for each acceptable unique identifier entered.

14. The communications system, as described in claim 1, wherein said sending entity selects the system specific transmission protocol to be used to communicate with said receiving entity.

15. The communications system, as described in claim 1, wherein said receiving entity selectively specifies activation of an automated return message for at least one unique identifier through which messages are received.

16. The communications system, as described in claim 1, wherein said receiving entity arranges automated billing to said sending entity through said entity identification system for products or services requested by and delivered to said sending entity.
